(19) United States
(12) Patent Application Publication
(10) Pub. No.: US 2012/0203594 A1
(43) Pub. Date: Aug. 9, 2012

(54) MONITORING MIGRATION BEHAVIOR OF USERS OF ELECTRONIC DEVICES AND RELATED SERVICE PROVIDERS

(76) Inventors: Sean A. Groer, Roswell, GA (US); William B. Hakes, Marietta, GA (US)

(21) Appl. No.: 13/452,431

(22) Filed: Apr. 20, 2012

(51) Int. Cl. G06Q 30/02

(52) U.S. Cl. 705/7.29

(57) ABSTRACT

Migration events such as switching from one smartphone to another, switching from one mobile carrier to another, and/or switching from one Internet Service Provider to another are monitored and reported. User account based applications that are installed on the smartphone or other electronic device of the user or are web based and accessed by the electronic device of the user gather information related to the migration. The information for a given user account is obtained from the application from time to time and compared to prior information that has been received for the same user account to detect differences resulting from a migration event. The migration events may be recorded in the aggregate and reported to reveal trends.

### TECHNICAL FIELD

Embodiments are related to the use of electronic devices and related service providers. More particularly, embodiments are related to monitoring user migration related to the electronic devices and service providers.

### BACKGROUND

Electronic devices are ubiquitous. For instance, mobile devices including mobile phones and mobile data devices have become a prevalent personal and business tool used by massive numbers of the population. Furthermore, most homes and businesses have at least one electronic device and a related data service for accessing the Internet.

One form of data service is to a fixed location. Internet service providers offer data services to the fixed location, such as a home or business, where a computer, tablet, or handheld device is used to access the Internet. Another form of data service is mobile data service. In particular, mobile phone service provides the convenience of having a portable telephone service at virtually any location and time. Such convenience has led many to cancel landline services altogether. Furthermore, the emergence of mobile smartphone devices, mobile handheld data devices, mobile tablet data devices, and mobile applications, including native, downloadable, and web-based mobile applications, has further bolstered the popularity of mobile phone service, mobile data service, and mobile devices.

While a large percentage of the population has one or more service provider subscriptions, competition among service providers is fierce. Therefore, service providers are always seeking a competitive advantage through marketing strategies such as new mobile device offerings, new subscriber plan offerings, and new mobile phone/data service features. The service providers may improve upon the effectiveness of marketing such offerings by having better competitive intelligence. In particular, better awareness of user migration among service providers and/or electronic devices may allow for predicting and measuring the effectiveness of such marketing strategies. However, service providers are limited in their ability to obtain information regarding such user migration.

A given service provider may have knowledge only of the number of subscribers it gains or loses in a given period, and the devices its own subscribers have used in the past and currently use. Therefore, a service provider may have no knowledge as to which other service provider a former or prospective subscriber has switched, and no knowledge as to which device a former or prospective subscriber has switched. Therefore, there is an incomplete awareness as to such user migration and as to the relative effectiveness between marketing strategies of the service provider and those of its competitors.

Various other entities may also be interested in user migration between devices and/or service providers. For instance, device manufacturers may be interested in determining user migration to and from their devices as well as to and from other manufacturers' devices. This may allow device manufacturers to determine which device models, device features, marketing efforts, and service provider partnerships are effective. Other examples are investors and financial analysts, as such information may lead to insight regarding current and future financial performance.

### SUMMARY

Embodiments address issues such as these and others by providing various ways to monitor user migration related to electronic devices and service providers. The monitoring of the user migration allows the determination of the number of users that have migrated to and/or from some aspect of the subscribed service, such as the service itself, the electronic device used with the service, or some feature of the electronic device such as the operating system.

Some embodiments provide a method of monitoring service provider migration of electronic device users. The method involves communicating with an application being accessed via an electronic device to obtain information from the application that identifies a service provider of the electronic device and identifies a user account of the application, the information thereby associating the user account with the service provider. The method further involves comparing the service provider associated with the user account to a service provider previously associated with the user account to determine whether the service provider for the user account is different than the service provider previously associated with the user account.

Some embodiments provide a method of monitoring mobile device migration of mobile device users. The method involves communicating with a mobile application of a mobile device to obtain information from the mobile application that provides an identifier of a mobile device and identifies a user account of the mobile application, the information thereby associating the user account with the identifier of the mobile device. The method further involves comparing the identifier of the mobile device associated with the user account to an identifier of a mobile device previously associated with the user account to determine whether the identifier of the mobile device for the user account is different than the identifier of the mobile device previously associated with the user account.

Some embodiments provide a method of monitoring mobile device operating system migration of mobile device users. The method involves communicating with a mobile application of a mobile device to obtain information from the mobile application that provides an identifier of a mobile device operating system and identifies a user account of the mobile application, the information thereby associating the user account with the identifier of the mobile device operating system. The method further involves comparing the identifier of the mobile device operating system associated with the user account to an identifier of a mobile device operating system previously associated with the user account to determine whether the identifier of the mobile device operating system for the user account is different than the identifier of the mobile device operating system previously associated with the user account.

Some embodiments provide a computer system that monitors service provider migration of electronic device users. The computer system includes a network connection and associated computer. The computer is configured to communicate through the network connection with an application that is accessed by a user via an electronic device to obtain information from the application that identifies a service provider used by the electronic device and identifies a user account of the application, the information thereby associating the user account with the service provider. The computer is further configured to compare the service provider associated with the user account to a service provider previously associated with the user account to determine whether the service provider for the user account is different than the service provider previously associated with the user account.

Some embodiments provide a computer system that monitors mobile device migration of mobile device users. The computer system includes a network connection and an associated computer. The computer is configured to communicate through the network connection with a mobile application of a mobile device to obtain information from the mobile application that provides an identifier of a mobile device and identifies a user account of the mobile application, the information thereby associating the user account with the identifier of the mobile device. The computer is further configured to compare the identifier of the mobile device associated with the user account to an identifier of a mobile device previously associated with the user account to determine whether the identifier of the mobile device for the user account is different than the identifier of the mobile device previously associated with the user account.

Some embodiments provide a computer system that monitors mobile device operating system migration of mobile device users. The computer system includes a network connection and an associated computer. The computer is configured to communicate with a mobile application of a mobile device to obtain information from the mobile application that provides an identifier of a mobile device operating system and identifies a user account of the mobile application, the information thereby associating the user account with the identifier of the mobile device operating system. The computer is further configured to compare the identifier of the mobile device operating system associated with the user account to an identifier of a mobile device operating system previously associated with the user account to determine whether the identifier of the mobile device operating system for the user account is different than the identifier of the mobile device operating system previously associated with the user account

### DESCRIPTION OF THE DRAWINGS

FIG. 1 shows an example of a mobile device environment having multiple carriers and multiple devices.

FIG. 2 shows an example of the sequence of a registration event.

FIG. 3 shows an example of the sequence of a first type of migration event where a user has switched to a new mobile device.

FIG. 4 shows an example of the sequence of a second type of migration event where a user has switched to a new service provider.

FIG. 5 shows an example of the sequence of a third type of migration event where a user has switched to a new mobile device operating system.

FIG. 6 shows an example of a database maintaining the information that allows the migration events to be tracked.

FIGS. 7A and 7B show an example of the logical operations of migration event monitoring and analysis.

FIG. 8 shows an example of a report for mobile device or operating system migration events resulting from the migration analysis.

FIG. 9 shows an example of a report for a mobile carrier migration events resulting from the migration analysis.

FIG. 10 shows an example of a report for internet service provider migration events resulting from the migration analysis.

### DETAILED DESCRIPTION

Embodiments provide ways of monitoring electronic device and service provider related user migration. In particular, a user account for an application is associated with some aspect of user migration, such as a service provider identity, the device model, and/or the device operating system. The application reports the user migration related information in association with the user account of the application to a monitoring system. The migration may then be tracked periodically to determine whether for a given user account of the application a migration event has occurred. The migration events may be reported in the aggregate to show the general migration trends that are occurring for devices, operating systems, service providers, and the like.

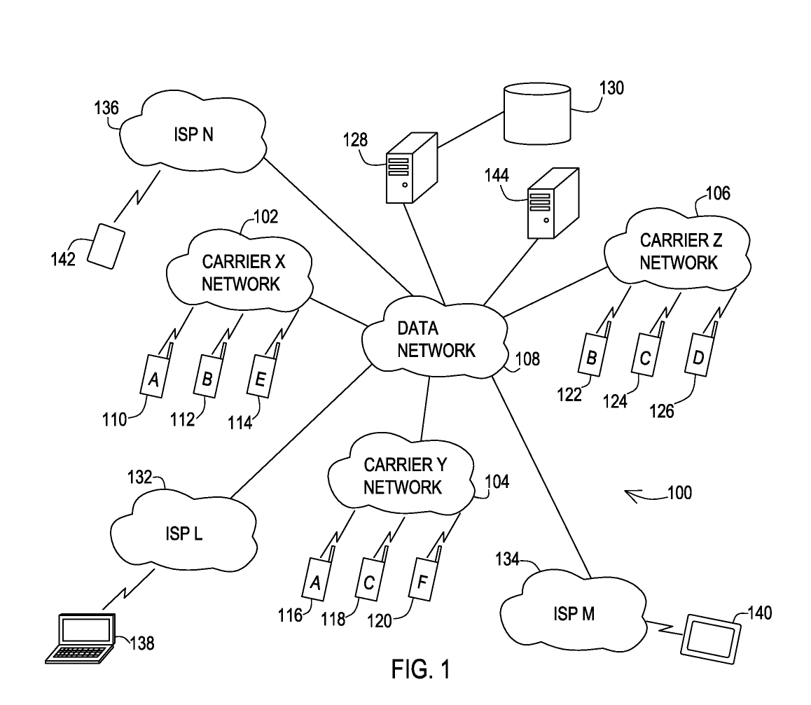

FIG. 1 shows an example of a communications environment 100 where embodiments may be implemented to monitor for user migration events. In this example, there are mobile carrier networks 102, 104, 106, internet service provider networks 132, 134, 136, and a general purpose data network 108 such as the Internet. Additionally, there are electronic devices such as mobile devices and particularly smartphones 110-126, handheld devices 142, tablet devices 140, and personal computers 138.

A user of an electronic device relies on a service provider to gain access to the data network 108 such as the Internet. For instance, users of smartphones 110, 112, 114 utilize a mobile carrier “X” 102 to communicate with the data network 108 while users of smartphones 116, 118, 120 utilize a mobile carrier “Y” 104 and users of smartphones 122, 124, 126 utilize a mobile carrier “Z” 106. From time to time, the user of a given smartphone may switch to a different mobile device for the same carrier, may switch to a different carrier for the same or a different smartphone, and may switch to a different operating system for the same or different smartphone. These migration events are of particular interest to the mobile carriers but may also be of interest to device manufacturers, operating system manufacturers, and the like.

Similarly, users of handhelds 142 which may be inclusive of smartphones utilizing a Wi-Fi data connection, tablets 140, and personal computers 138 utilize internet service providers (ISP) to gain access to the data network 108 from a fixed location such as a home or business. In the example shown, the user of the personal computer 138 is using an ISP “L” 138, while the user of the tablet 140 is using an ISP “M” 134 and the user of the handheld 142 is using an ISP “N” 136. These users may switch from one ISP to another from time to time, and these migration events are of particular interest to the ISPs.

The users of these electronic devices often access application programs such as games, social networking, streaming music, navigation, and the like via the electronic devices. The application programs may be native to the electronic device, downloaded from an electronic marketplace accessed through the data network 108, web-based and accessed through a web browser, or accessed in some other similar manner. For instance, a server computer 144 may provide a marketplace for the transfer of the applications to the electronic device or may alternatively provide the web-based application that is accessed via a browser or other program of the electronic device.

These applications may be user account based. The user establishes a user account which is maintained within an account database. For instance, the application may communicate with a server computer 128 that maintains account information within a database 130 or with a similar server and database configuration. The user account within the database 130 may track user preferences, contacts, messaging, progress within a game or other historical usage information, and so forth for the application. Thus, the application establishes frequent communications with the server computer 128 to exchange this information as part of the function of the application.

The user account based application becomes a source of information for monitoring the migration events. For instance, the application may collect information from the memory of the electronic device such as a device manufacturer name or identifier, device model name or other identifier, device operating system name or other identifier, and/or service provider name or other identifier. In the case of a smartphone, the application may obtain the telephone number of the device. Furthermore, for downloaded applications, the version of the application is specific to the operating system of the electronic device and therefore the application itself represents the particular operating system being used by a given electronic device and can report that information even if the operating system is not available from the memory of the device.

To the extent some information is not available directly from the phone, the application may report standardized information that is available, such as an international mobile equipment identity (IMEI). Furthermore, communication with the application may rely on a network address, such as an Internet Protocol (IP) address that is revealed by those communications. Such standardized information as the IMEI and/or the IP address can be used to look-up associated information in publicly available or proprietary databases as appropriate to discover service provider identities, device models, and the like.

To address any privacy concerns of the user, during the installation of the application to the electronic device, or prior to loading a web-based application via a browser, mobile applications may provide terms and conditions to the user. These disclose that such information will be obtained and reported by the application if the user agrees to complete the installation or loading of the application.

Once the application is installed and launched or loaded via the browser, the application may then collect and report such information to the server computer 128 which maintains the user account information in the database 130. In this case, the user account information may include the migration event information such as the device model, the operating system, and/or the service provider. Additional information may also be collected directly from the user during the registration of the application, such as an email address, a physical address, and the like.

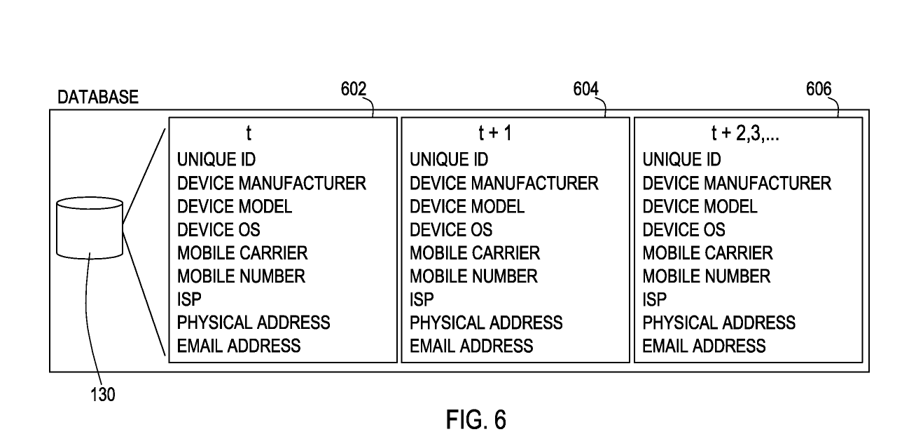

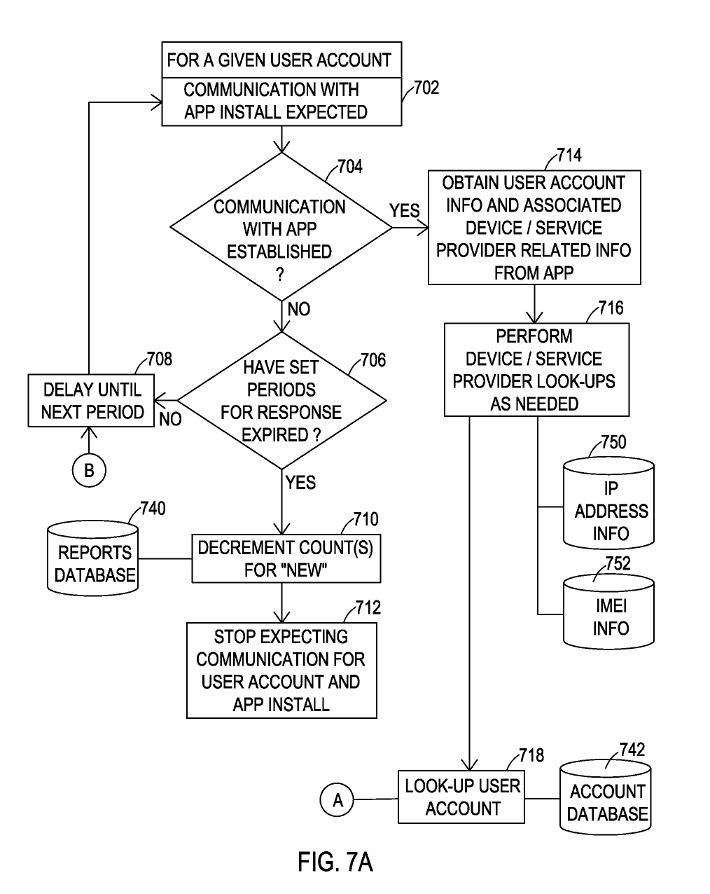

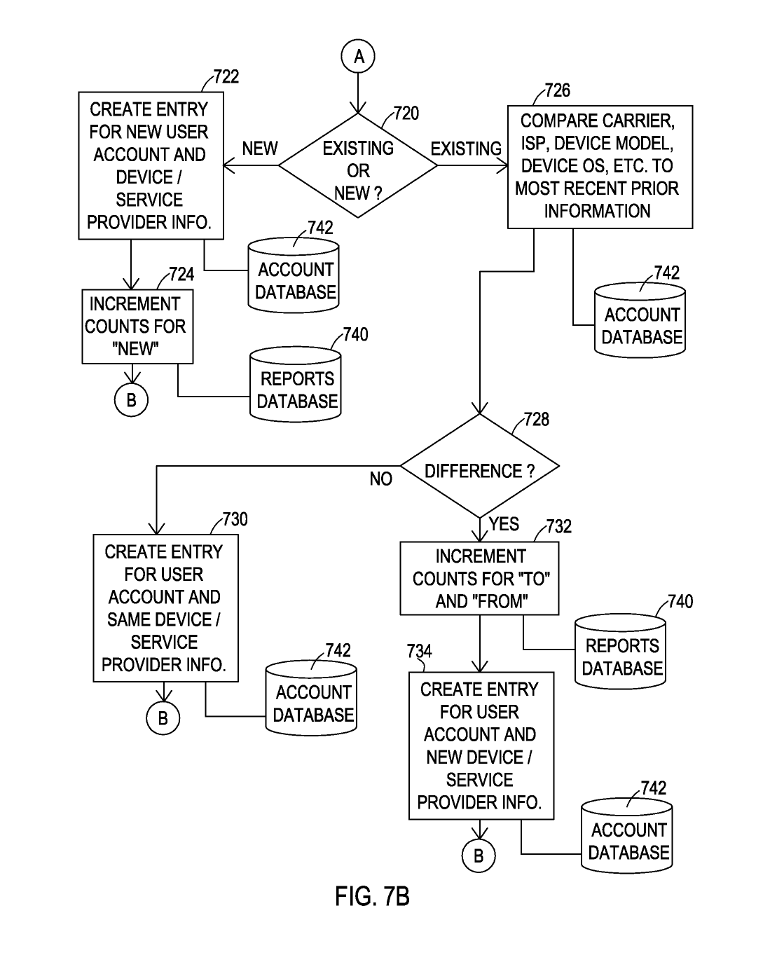

The server computer 128 or another computer having access to the database 130 may then analyze the information to detect the occurrence of migration events. Examples of such analysis are discussed in more detail below with reference to FIGS. 6, 7A, and 7B. The analysis may then produce reports that aggregate the migration events that have been detected over a period of time to allow trends to be observed. Detecting the trends may then allow the marketing efforts to be adjusted.

The server computer 128 or other computer communicating with the application has a network connection linking the server computer 128 or other computer to the data network 108. The server computer 128 or other computer then transmits and receives data via this network connection to the data network to exchange information related to migration events with the application.

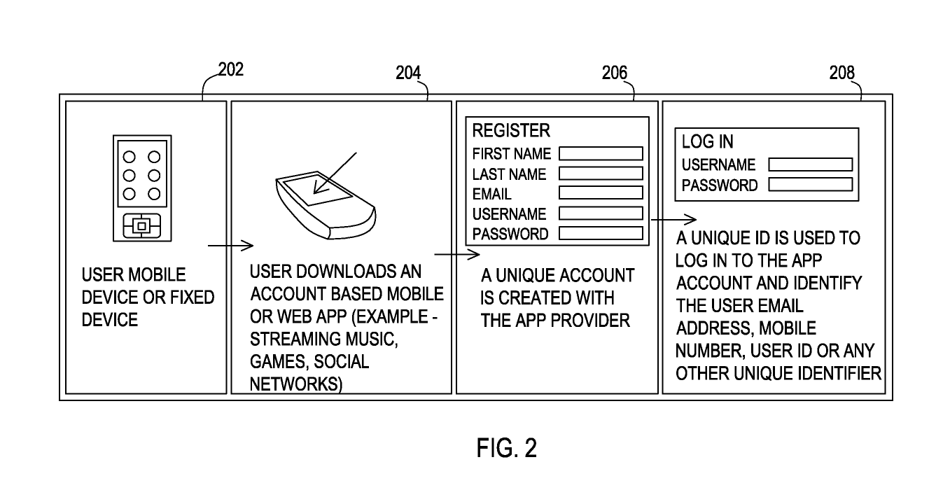

FIG. 2 shows one example of a sequence of events that may occur when a user decides to use an application. Initially, the user acquires a mobile or fixed service device at action 202. It will be appreciated that a single device, such as a smartphone or mobile network capable tablet, may serve as both a mobile device and a fixed service device considering the device can operate in either mode.

Upon acquiring the electronic device, the user then obtains a user account based application such as by downloading an application from an online marketplace or by loading a web-based application at action 204. Where this is the first use of the application by this particular user, then user registers with the application by creating a user account at an action 206, the user account having a unique identifier assigned, such as the username chosen by the user or an identifier assigned by the server computer 128. Thereafter, the user accesses the application by logging into the account with the unique username or other identifier at an action 208. The application then obtains the information used to monitor for migration events when the user accesses the application.

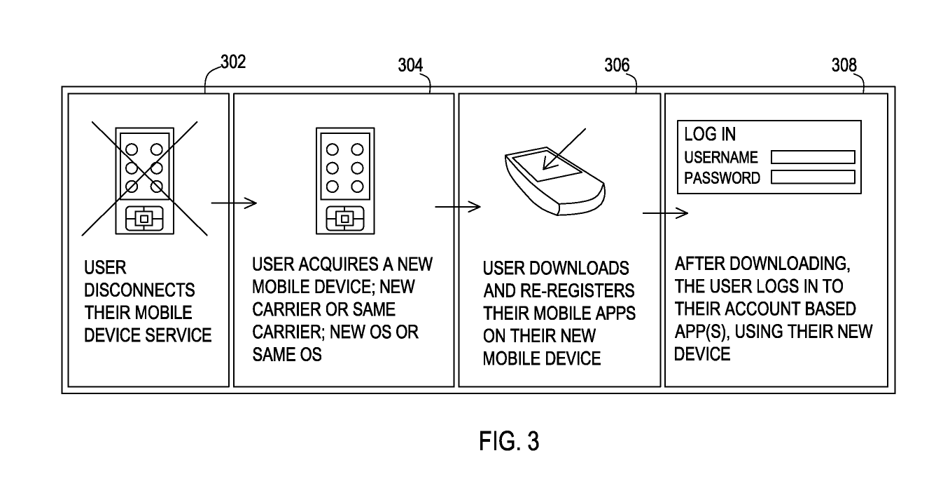

FIG. 3 shows one example of a sequence of events that may occur when a user decides to switch mobile devices, which is of particular interest to mobile carriers, device manufacturers, investors, and the like, who are trying to monitor which devices are of interest to users. Initially, the user disconnects the existing service being provided to the device at an action 302. The user then obtains and activates service on the new device. The service provider for the new device may be the same or may be different, and the operating system being used may be the same as for the prior device or may be different.

Once the new device has active service, the user then downloads and re-registers the application for which the user previously created the user account in the actions of FIG. 2 at an action 306. The user then logs in to the application using the existing user account that was previously established using the prior device at an action 308.

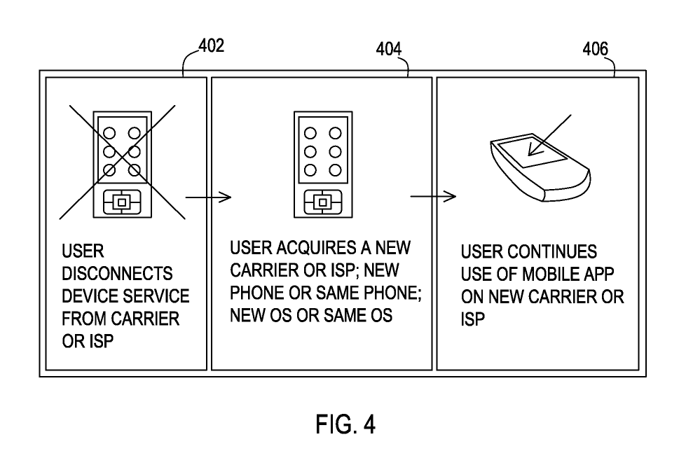

FIG. 4 shows one example of a sequence of events that may occur when a user decides to switch service providers. In the case of a smartphone or a mobile network capable tablet, the service provider may be a mobile carrier. In the case of any electronic device that can utilize a fixed location service such as through a Wi-Fi connection, the service provider may be an ISP. Initially, the user disconnects the existing service being provided at an action 402. The user then acquires a new service provider such as a new mobile carrier or a new ISP at an action 404.

Acquiring the new service provider may involve continuing to use the same electronic device or may involve obtaining a new device. If a new device is obtained as a result of the switch of service providers, as may sometimes be the case when switching mobile carriers where the smartphone is specific to the mobile carrier, then the remaining actions match those from FIG. 2. However, where the same electronic device is being used with the new service provider, then the user continues to use the application in the same manner and with the same user account at an action 406.

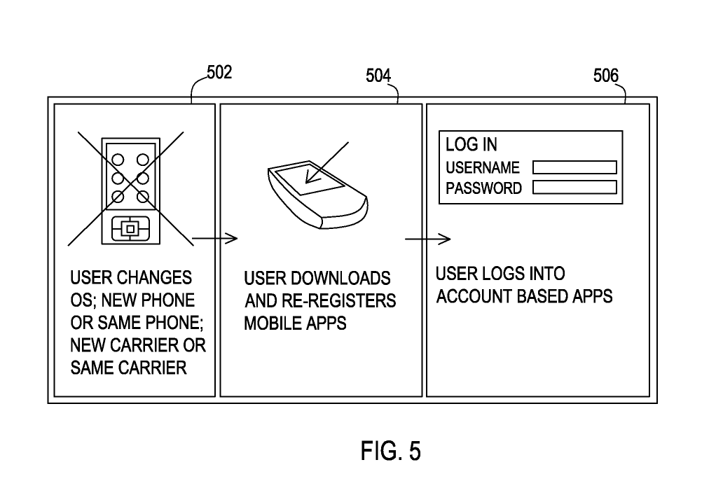

FIG. 5 shows one example of a sequence of events that may occur when a user decides to switch operating systems, which is also of particular interest to mobile carriers who are trying to monitor which device features are of interest to users. This switch of operating systems at an action 502 may occur without switching mobile carriers and/or without switching devices where a given device may be capable of utilizing different operating systems while operating on a given carrier's network. Alternatively, this switch may occur as a result of switching devices where the new device has a different operating system than the prior device, and this switch may occur either without switching mobile carriers or in conjunction with switching mobile carriers.

Once the new operating system is active on the current service and device, the user then downloads and re-registers the application for which the user previously created the user account in the actions of FIG. 2 at an action 504. The user then logs in to the application using the existing user account that was previously established using the prior device at an action 506.

In each of these migration events of FIGS. 3-5, the application has been reporting information in association with the user account before the migration event occurred and then continues reporting the information in association with the same user account after the migration event. FIG. 6 shows an example of the records in the database 130 that have been created as a result of a given installation of the application reporting the information in association with the particular user account.

As shown in FIG. 6, the database creates a current record 602 for time t that is also for a particular user account as identified by a unique ID such as a username. The given application installation has reported information that has been obtained from the phone. In some embodiments, all of the information has been reported directly by the application. In other embodiments, the application has reported information such as the IMEI and/or the IP address and then a look-up in a public or proprietary database as appropriate has been done to obtain information saved in the current record 602. The record 602 can include information such as the device manufacturer and model, the operating system, the mobile carrier, the mobile number, the ISP, the physical address, and the email address.

The database 130 may store additional records for the same user account that have been created prior to the current record 602. These prior records 604, 606, and so on may contain information that differs from the information in the current record 602 which reflects that some migration event for this particular user has occurred. These prior records 604, 606, and so on allow changes in the information within the record to be detected and reported but may also reveal effects from seasonality and other effects that reveal themselves over the course of a particular length of time.

Where the application may be installed on multiple devices, even for a same user account, the records 602 of FIG. 6 may each be on a per installation basis. Thus, a given user account may have multiple records, one for each installation of the application across multiple devices, for instance, one record for a smartphone, one for a tablet, one for a personal computer, and one for a web based launch. The information in these records 602 identify the type of installation that is represented, thus it is known that one record represents a smartphone while another represents a tablet and so forth. This can be known from recognizing the device model information as pertaining to a smartphone versus a tablet and so forth, for example. Alternatively, a user account may have a single record 602 but may keep track of multiple application installations. So, for example, each entry may track multiple devices and again, each device installation being tracked is recognized as a smartphone versus a tablet and so forth.

FIGS. 7A and 7B show an example of logical operations that may be performed by various embodiments of the server computer 128 or other computer with access to the database 130 to monitor for and aggregate migration events. It will be appreciated that this is one specific example of the logical operations and that variations thereof fall within the scope of the embodiments being disclosed herein. These operations of this particular example occur per user account for a given application that may be either installed on a user's electronic device or a web based application accessed by a user's electronic device via a web browser or other viewer.

Initially, a communication operation 702 expects to communicate with a given application installation for a given user account. For instance, the user account may have multiple installations of the application, one being a smartphone installation and another being a tablet or other handheld installation as one specific example, or in another case, there are multiple users of the same application account. Other examples may involve installation on a personal computer and/or web based launch of the application from a smartphone, tablet, or personal computer.

This communication operation 702 may involve the application itself initiating communication with the server computer 128 upon the user launching the application or upon a particular time for reporting occurring. In such a case, the server computer 128 receives a request from the application to begin communicating with the application. Similarly, a web based application may communicate with the server computer 128 upon being launched by the user. As an alternative, the communication operation 702 may involve the server computer 128 initiating communication with the application on the smartphone, tablet, personal computer, or other handheld or with the web based application at a particular time for reporting. The time for reporting may be chosen as desired, such as periodically at regular intervals or even at random times within a given window of time.

A query operation 704 detects whether expected communication with a given installation of the application has been established. As described above, an expected communication of a given application installation may be from a particular electronic device or from a web based launch. If the communication has failed to established when expected, such as because the given application installation for the user account did not initiate contact as expected or because the server computer 128 attempted to initiate communication but received no response from the given application installation for the user account, then operational flow proceeds to a query operation 706.

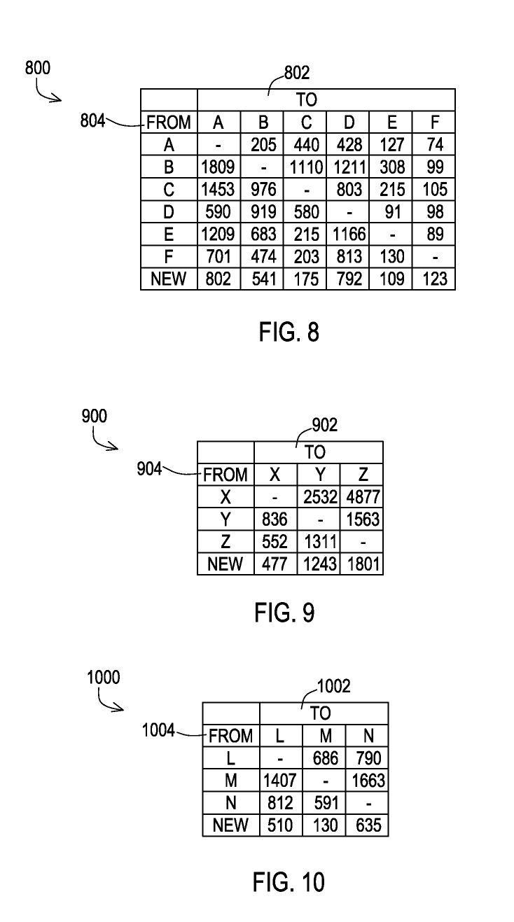

The query operation 706 detects whether a set number of period for response has expired. For instance, it may be acceptable that a given installation of the application for a particular user account not communicate with the server computer 128 because it may be presumed that the electronic device may be powered off, or the user has not used the application lately, or for similar reasons. To account for such possibilities, the logical operations wait until a next period for communication with the given application installation for the particular user account at a delay operation 708 when the query operation 706 detects that the set periods for response have not expired. This number of periods may be set as desired depending upon how many periods one deems acceptable for the given application installation for a particular user account to be unresponsive but still considered to be potentially an active installation.

Where the set number of periods for response has expired as determined by the query operation 706, a numerical value of counts for net “NEW” user accounts in a reports database 740 that is relevant to the type of application installation being considered is decremented. For instance, if the expected communication is from a smartphone installation of the application, then any count relevant to a smartphone installation may be decremented at a decrement operation 710. This may include a net “NEW” count pertaining to the smartphone device model and may also pertain to a net “NEW” count pertaining to the mobile carrier. Reports collected within the reports database 740 that reflect the changes to the “NEW” count as well as other counts are shown in FIGS. 8-10 which are described in more detail below. Additionally, the reports database 740 may be a sub-database contained within the database 130 of FIG. 1.

As an alternative to decrementing a net “NEW” count at the decrement operation 710, there may instead be a net “LOST” account that is used to track activity pertaining to new and lost installations which is incremented. Furthermore, there may be gross “NET” and gross “LOST” accounts that are maintained, and in that case the gross “LOST” account would be incremented at the operation 710.

At this point, the given application installation for a particular user account is considered to no longer exist. Therefore, the logical operations of this particular example stop expecting further communications from this given application installation for the particular user account at a stop operation 712. For instance, the user account record 602 of FIG. 6 that is dedicated to this particular installation may be flagged as closed or may be removed from an accounts database 742, which may also be a sub-database contained within the database 130 of FIG. 1. As described below, when a new installation and/or user account are discovered, a record is created and therefore should this closed installation for a given user account reappear at some point in the future, it may be treated as a new installation of the particular user account which will reverse the change to the net “NEW” count. Where an individual record 602 tracks multiple installations, then a given installation within the single record 602 may be flagged as closed or may be removed from the record at the stop operation 712.

Returning to query operation 704, upon communication being established with the given application installation for a particular user account, operational flow then proceeds to account operation 714. Here, the user account information including any unique ID of the user account is obtained from the given application installation for a particular user account. Information to be associated with the user account for this installation of the application is also obtained. Examples of such information include those items listed for the record 602 of FIG. 6, such as the name or other identifier of the device model, the name or other identifier of the mobile carrier or ISP, the name or other identifier of the operating system, the mobile phone number, the email address, and the physical address.

At a look-up operation 716, any information needed for the record 602 that has not directly been obtained from the application is looked up within a related database. For instance, if the application reports an IP address rather than a mobile carrier or ISP, the IP address may be looked up within an IP address database 750 that associates an IP address range to a particular mobile carrier or ISP. Similarly, if the application reports and IMEI value rather than a device model, the device model may be obtained by looking up the IMEI within a database 752. If look-ups such as these are not required, then operational flow proceeds directly to a look-up operation 718.

At the look-up operation 718, the user account is looked up within the account database 742 to find a related entry if one exists. A query operation 720 detects whether an entry already exists for this given installation and particular user account.

If no entry exists, such as where there is no record for this user's unique ID or where there is no record of this type of installation of the application for an existing user ID, then a new entry is made within the account database 742 at a creation operation 722 by writing the device model, operating system, mobile carrier or ISP, and so forth to the record 602. For instance, a new record may be created to reflect a new unique ID or a new entry within an existing record may be created where this is a new type of application installation of an existing ID. As an example of the latter, a record may exist for a unique ID that reflects a smartphone installation. However, the present communication is with a tablet installation for the unique ID and in that case a new entry is made to reflect that the unique ID also has a tablet installation in addition to the smartphone installation. As discussed above, in some embodiments this may result in a separate record 602 for the table installation while in other embodiments, a single record 602 may be modified to reflect both the smartphone and the tablet installation.

For this new application installation and/or user account, a value representing a net “NEW” count may then be incremented within the reports database 740 at an increment operation 724. As discussed above, this net “NEW” count tracks new and lost installations and/or accounts. Furthermore, if this is a reappearing installation that is now considered “NEW,” then this offsets a prior decrement to the “NEW” count. Additionally as discussed above, there could be a net “LOST” count instead which would be decremented by this new installation and/or account. Furthermore, there could be gross “NEW” and gross “LOST” counts and this new installation and/or account would increment the appropriate gross “NEW” count in that case.

An example of incrementing the net “NEW” count follows. If there is no smartphone for the unique ID of the present communication with the application, then a report that is tracking smartphone device migration will have the net “NEW” incremented for the particular model of smartphone that has been identified by this exchange of information with the application.

Returning to the query operation 720, if the unique ID and installation is found, then operational flow proceeds to a comparison operation 726. An example of finding that the unique ID and installation exists is where it is found that for this communication from a particular unique ID and from a smartphone installation, there is already a smartphone installation for this unique ID in the accounts database 742.

At the comparison operation 726, the information that has been obtained from the application during this communication is compared to the information that is present in the prior record 604 within the account database 742 for this unique ID and installation. So, for example, if this communication for this unique ID is for a smartphone installation, the currently obtained information pertaining to the smartphone installation is compared to the information pertaining to the smartphone installation from the prior record. This would include such items as the smartphone model and/or manufacturer, the smartphone operating system, the mobile carrier, mobile number, email address, physical address, and in some cases the ISP where the smartphone has used a Wi-Fi data connection with the application.

At a query operation 728, it is detected whether there is a difference in any of the current information relative to the information of the prior record 604 for this particular installation of the application. For example, if this installation is a smartphone installation, it is detected whether the information about the smartphone installation from the prior record 604 is different. If there is no difference, then there are no counts to update within the report database 740. Therefore, the new record 602 is created within the accounts database 742 that reflects the currently received information which happens to be the same information from the prior record 604 at a creation operation 730.

Returning to the query operation 728, if there is a difference then operational flow proceeds to an increment operation 732. A difference in the current information from the information of the prior record is an indication of some type of migration event. For instance, the difference may be a different device model as occurred in FIG. 3. Another difference may be a different ISP or mobile carrier as occurred in FIG. 4. While yet another difference may be a different operating system as occurred in FIG. 5. Here, the relevant counts for “TO” and “FROM” are incremented within the reports database 740 to represent the migration event that has happened at the increment operation 732, where the “TO” count is for the new device, carrier/ISP, or operating system and the “FROM” count represents the prior.

The current information is then recorded to the record 602 within the account database 742 at a creation operation 734 by writing the device model, operating system, mobile carrier or ISP, and so forth to the record 602. This information is then available for comparison at the next communication session with the given application installation for this particular user account.

While the logical operations of FIGS. 7A and 7B have been discussed in the context of monitoring all application installations regardless of device, it will be appreciated that such operations may instead be focused on a single installation type. For instance, in some embodiments it may be desirable to monitor only smartphone related migration events. In that case, the communication that is established may occur only for smartphone installations of the application. In another example, it may be desirable to only monitor tablets that utilize mobile carriers. In yet another example, it may be desirable to only monitor devices that utilize fixed location ISPs.

FIGS. 8-10 show examples of reports containing data that may be generated and output. The generation of the reports may occur by incrementing counts within the reports database 740 to convey the migration events in the aggregate as discussed above in FIGS. 7A and 7B. These reports may be output via display, printed copy, digital copy for transfer over the data network 108, and so forth.

Viewing the migration events in the aggregate may allow trends in the migration events to be better perceived and understood. For instance, the report 800 of FIG. 8 shows migration pertaining to the smartphone device models or operating systems from FIG. 1. The set of columns 802 represent the smartphone model or operating system that users have switched to while the set of rows 804 represent the smartphone model or operating system that users have switched from during the most recent period. From these columns 802 and rows 804, the losses and gains can be seen. For instance, device “A” gained 1809 devices as a result of the loss of 1809 “B” devices, while device “B” gained 205 devices as a result of the loss of 205 “A” devices. Summing the columns 802 gives the total number gained per device while summing the rows 804 gives the total number of losses per device.

It should be noted that this information being reported here can aggregate in a very large sense, such as across multiple mobile carriers and across a large geographic area. Because the applications are typically independent of the mobile carrier, instances of an application can provide information about migration events from many mobile carriers. Alternatively, this information may be filtered so that the report 800 is filtered to be specific to a particular mobile carrier or specific to a geographical area such as a particular city. The physical address, the mobile phone number, the ISP, and/or other geographically relevant information that may be gathered from the application and stored in the account database 742 allows the geographical filtering to occur.

In the case of device models, in this particular example of FIG. 8 it appears that more users are switching to device model “A” than to other models. If this information aggregates for all mobile carriers, then a mobile carrier seeing this information may then know the smartphone device migration happening industry wide, as opposed to only within their own business. This may indicate to a mobile carrier that providing the device model “A” as an option might attract and/or retain more customers. On the other hand, it appears that more users are switching away from device model “E” than from other models. This may indicate to a mobile carrier that device model “E” should be phased out of inventory or not selected as a future option.

Additionally, mobile carriers can determine information about brands. For instance, if device models “E” and “F” are from the same manufacturer while the models “A” through “D” are from different manufacturers, the relative decline in the use of “E” and “F” across the industry may reveal that users are no longer interested in phones by that manufacturer.

Such migration trends among smartphone device models or operating systems may be localized in nature and may not be as evident in the aggregate for the whole geographical space for the industry. Therefore, the report may be filtered by geography, such as looking at the trends within a given city. This may reveal that device model “A” is the device of choice in one city while device “D” is the device of choice in another city. This allows mobile carriers to make decisions about varying their products by geography.

FIG. 8 includes the “NEW” row which indicates that the number represents a net addition of the device of the columns 802, as opposed to a migration from another device. This may also be useful to determine which device models are attracting new lines of service, such as which phones that teenagers and young adults tend to be choosing as their first smartphone.

FIG. 9 shows a report 900 that is representative of migration events pertaining to users switching from one mobile carrier from FIG. 1 to another. The set of columns 902 represent the mobile carrier that users have switched to while the set of rows 904 represent the mobile carrier that users have switched from during the most recent period. From these columns 902 and rows 904, the losses and gains can be seen. For instance, mobile carrier “X” gained 836 accounts as a result of the loss of 836 “Y” accounts, while mobile carrier “Y” gained 2532 accounts as a result of the loss of 2532 “X” accounts. Summing the columns 902 gives the total number gained per mobile carrier while summing the rows 904 gives the total number of losses per mobile carrier.

It should be noted that this mobile carrier information being reported can aggregate in a very large sense, such as across a large geographic area or in a very localized sense such as for a particular city using the geographically relevant information from the application. In this particular example of FIG. 9 it appears that more users are switching to mobile carrier “Z” than to other mobile carriers. On the other hand, it appears that more users are switching away from mobile carrier “X” than from other mobile carriers.

Such migration trends among mobile carriers may also be localized in nature and may not be as evident in the aggregate for the whole geographical space for the industry. Therefore, the report may be filtered by geography, such as looking at the trends within a given city. This may reveal that mobile carrier “Z” is the mobile carrier of choice in one city while mobile carrier “Y” is the mobile carrier of choice in another city. This allows mobile carriers to make decisions about how to market to particular geographical areas.

FIG. 9 also includes the “NEW” row which indicates that the number represents a net addition of the line of service for the mobile carrier of the columns 902, as opposed to a migration from another mobile carrier. This may also allow mobile carriers to make decisions about how to market to those potential customers who have yet to purchase mobile carrier service.

FIG. 10 shows a report 1000 that is representative of migration events pertaining to users switching from one ISP from FIG. 1 to another. The set of columns 1002 represent the ISP that users have switched to while the set of rows 1004 represent the ISP that users have switched from during the most recent period. From these columns 1002 and rows 1004, the losses and gains can be seen. For instance, ISP “L” gained 1407 accounts as a result of the loss of 1407 “M” accounts, while ISP “M” gained 686 accounts as a result of the loss of 686 “L” accounts. Summing the columns 1002 gives the total number gained per ISP while summing the rows 1004 gives the total number of losses per ISP.

It should be noted that this ISP information being reported can also aggregate in a very large sense, such as across a large geographic area or in a very localized sense such as for a particular city using the geographically relevant information from the application. In this particular example of FIG. 10, it appears that more users are switching to ISP “N” than to other ISPs although ISP “L” is also attracting a lot of customers as well. On the other hand, it appears that more users are switching away from ISP “M” than from other ISPs.

As for mobile carriers, such migration trends among ISPs may also be localized in nature and may not be as evident in the aggregate for the whole geographical space for the industry. Therefore, the report may be filtered by geography, such as looking at the trends within a given city. This may reveal that ISP “N” is the ISP of choice in one city while ISP “L” is the mobile carrier of choice in another city. This allows mobile carriers to make decisions about how to market to particular geographical areas.

FIG. 10 also includes the “NEW” row whose value represents a net addition of the line of service for the ISP of the columns 1002, as opposed to a migration from another ISP. This may also allow ISPs to make decisions about how to market to those potential customers who have yet to purchase ISP service.

While embodiments have been particularly shown and described, it will be understood by those skilled in the art that various other changes in the form and details may be made therein without departing from the spirit and scope of the invention.

What is claimed is:

1. A method of monitoring service provider migration of electronic device users, comprising:
communicating with an application being accessed via an electronic device to obtain information from the application that identifies a service provider of the electronic device and identifies a user account of the application, the information thereby associating the user account with the service provider;
comparing the service provider associated with the user account to a service provider previously associated with the user account to determine whether the service provider for the user account is different than the service provider previously associated with the user account.

2. The method of claim 1, wherein the service provider is a mobile carrier and wherein the electronic device is a mobile device.

3. The method of claim 1, wherein the service provide is an internet service provider.

4. The method of claim 3, wherein the electronic device is a personal computer, a tablet, or a handheld device.

5. The method of claim 1, wherein the application is installed on the electronic device

6. The method of claim 1, wherein the application is web-based and accessed by the electronic device.

7. The method of claim 1, further comprising:
updating a report that shows a number of electronic device users that have been lost and have been gained for at least one service provider based on determining whether the service provider for the user account is different than the service provider previously associated with the user account.

8. The method of claim 1, further comprising:
outputting a data that indicates whether the service provider for the user account is different than the service provider previously associated with the user account.

9. The method of claim 1, wherein communicating with the application occurs periodically.

10. The method of claim 1, wherein communicating with the application comprises receiving a request to communicate from the application.

11. The method of claim 1, wherein comparing the service provider associated with the user account to a service provider previously associated with the user account comprises performing a look-up within a database of the user account to find the service provider previously associated with the user account.

12. The method of claim 11, further comprising writing the service provider associated with the user account to the database.

13. A method of monitoring mobile device migration of mobile device users, comprising:
communicating with a mobile application of a mobile device to obtain information from the mobile application that provides an identifier of a mobile device and identifies a user account of the mobile application, the information thereby associating the user account with the identifier of the mobile device;
comparing the identifier of the mobile device associated with the user account to an identifier of a mobile device previously associated with the user account to determine whether the identifier of the mobile device for the user account is different than the identifier of the mobile device previously associated with the user account.

14. The method of claim 13, further comprising:
updating a report that shows a number of mobile device users that have been lost and have been gained for at least one mobile device model based on determining whether the identifier of the mobile device for the user account is different than the identifier of the mobile device previously associated with the user account.

15. The method of claim 13, further comprising:
outputting data that indicates whether the identifier of the mobile device for the user account is different than the identifier for the mobile device previously associated with the user account.

16. The method of claim 13, wherein communicating with the mobile application occurs periodically.

17. The method of claim 13, wherein communicating with the mobile application comprises receiving a request to communicate from the mobile application.

18. The method of claim 13, wherein comparing the identifier of the mobile device associated with the user account to an identifier of a mobile device previously associated with the user account comprises performing a look-up within a database of the user account to find the identifier of the mobile device previously associated with the user account.

19. The method of claim 18, further comprising writing the identifier of the mobile device associated with the user account to the database.

20. The method of claim 13, wherein the identifier of the mobile device is a mobile equipment identity number.

21. The method of claim 13, wherein the identifier of the mobile device is a mobile device model name.

22. A method of monitoring mobile device operating system migration of mobile device users, comprising:
communicating with a mobile application of a mobile device to obtain information from the mobile application that provides an identifier of a mobile device operating system and identifies a user account of the mobile application, the information thereby associating the user account with the identifier of the mobile device operating system;
comparing the identifier of the mobile device operating system associated with the user account to an identifier of a mobile device operating system previously associated with the user account to determine whether the identifier of the mobile device operating system for the user account is different than the identifier of the mobile device operating system previously associated with the user account.

23. The method of claim 22, further comprising:
updating a report that shows a number of mobile device users that have been lost and have been gained for at least one mobile device operating system based on determining whether the identifier of the mobile device operating system for the user account is different than the identifier of the mobile device operating system previously associated with the user account.

24. The method of claim 22, further comprising:
outputting data that indicates whether the identifier of the mobile device operating system for the user account is different than the identifier for the mobile device operating system previously associated with the user account.

25. The method of claim 22, wherein communicating with the mobile application occurs periodically.

26. The method of claim 22, wherein communicating with the mobile application comprises receiving a request to communicate from the mobile application.

27. The method of claim 22, wherein comparing the identifier of the mobile device operating system associated with the user account to an identifier of a mobile device operating system previously associated with the user account comprises performing a look-up within a database of the user account to find the identifier of the mobile device operating system previously associated with the user account.

28. The method of claim 27, further comprising writing the identifier of the mobile device operating system associated with the user account to the database.
